(19) United States
(12) Patent Application Publication
(10) Pub. No.: US 2021/0097119 A1
(43) Pub. Date: Apr. 1, 2021

(54) EXPANDING AN ONLINE CONNECTION NETWORK BASED ON DIGITAL IMAGES OF PRINTED MEDIA

(71) Applicant: Microsoft Technology Licensing, LLC, Redmond, WA (US)

(72) Inventors: Yoshitake Komada, Los Altos, CA (US); Akihiro Maeda, Palo Alto, CA (US); Yuta Labur, San Jose, CA (US); Thao Bach, Mountain View, CA (US); Yuan Cheng, San Jose, CA (US); Alex Ting Yiao Wong, Sunnyvale, CA (US); Maiko Takahashi Huang, San Jose, CA (US); Guangyi Zhou, Redwood City, CA (US); Saif Z. Ebrahim, Santa Clara, CA (US)

(21) Appl. No.: 16/589,049

(22) Filed: Sep. 30, 2019

(51) Int. Cl. G06F 16/9535; G06F 16/93; H04L 29/08

(52) U.S. Cl. CPC G06F 16/9535; H04L 67/1097; G06F 16/93

(57) ABSTRACT

Techniques for expanding an online connection network based on digital images of printed media are provided. In one technique, analysis data that is generated based on analyzing a digital image of a physical medium is received. The digital image is generated by a computing device of a scanning entity. One or more data items are identified within the analysis data. Based on the identified data item(s), it is determined whether a profile database includes a profile that includes a data item that matches one of the identified data item(s). In response to a positive determination, profile data about a scanned entity that is the subject of content on the physical medium and that is different than the scanning entity is retrieved from the profile. In response to identifying the profile, the profile data is transmitted over a computer network to be displayed on the computing device of the scanning entity.

### TECHNICAL FIELD

The present disclosure relates to digital image processing and, more particularly, to expanding an online connection network based on processing digital images of printed media.

### BACKGROUND

In many countries of the world, people exchange physical cards that contain information about the respective person. A person with a card may use the card to contact (e.g., call or email) the person whose information is contained on the card. However, in the vast majority of cases, the exchange of such cards does not translate into a lasting connection. If a person with a card does not affirmatively contact the person whose information is contained on the card, then neither person is likely to ever see (or otherwise interact with) the other person again unless there is a chance meeting in the future. Therefore, the utility of such physical cards has not been fully realized.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for processing scanned business cards, in an embodiment;

FIG. 2 is a flow diagram that depicts an example process for processing scanned business cards, in an embodiment;

FIGS. 3A-3E are example screenshots of a user interface of a client application that executes on a computing device and that is used to generate and process digital images, in an embodiment;

FIGS. 4A-4I are example screenshots of a user interface of a client application that executes on a computing device and that is used to present information about scanees to a scanner, in an embodiment;

FIG. 5 is a flow diagram that depicts an example process for generating edit notification messages, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A method and system are provided for processing information contained within a digital image of a printed physical medium, such as a business card. A user (referred to herein as the “scanner”) operates a computing device to generate the digital image, where the information contained within the digital image pertains an entity (referred to herein as the “scanee”), such as a user or an organization. The information is used to perform a first look up for a profile or an account that matches the information. If there is a match (i.e., a profile or account is identified), then profile information of the scanee is presented to the scanner, including common elements or entities between the scanner and the scanee, such as common connections in an online network. If a match is not found (i.e., a profile or account is not identified in the first lookup), then other information in the digital image is used to perform a second look up for another profile or an account and determine whether there are common elements or entities between the scanner and an entity (e.g., a company) corresponding to the other profile/account.

Although the following description provides examples involving business cards, embodiments may include other types of cards that include non-business-related information, either additionally or exclusively. An example of another type of card may include only personal information, such as a personal address (of a person named on the card) as opposed to a business address. An example of another type of card is a school or academic card that a full-time or part-time student might have, where the card identifies an academic institution at which the student is currently enrolled. Another example is a resume that includes personal information about a person and information about the person's work and/or academic history.

Embodiments improve computer-related technology pertaining to digital images by finding scanned entities in an online network and leveraging the corresponding information in conjunction with network information pertaining to the scanner to produce relevant information for the scanner. In this way, the scanner is provided a richer experience with respect to the scanee than the scanner would otherwise have without access to the online network. Additionally, the produced information may be retrieved in real-time over a computer network so that latency between generating a digital image to presenting the produced information is minimal.

### System Overview

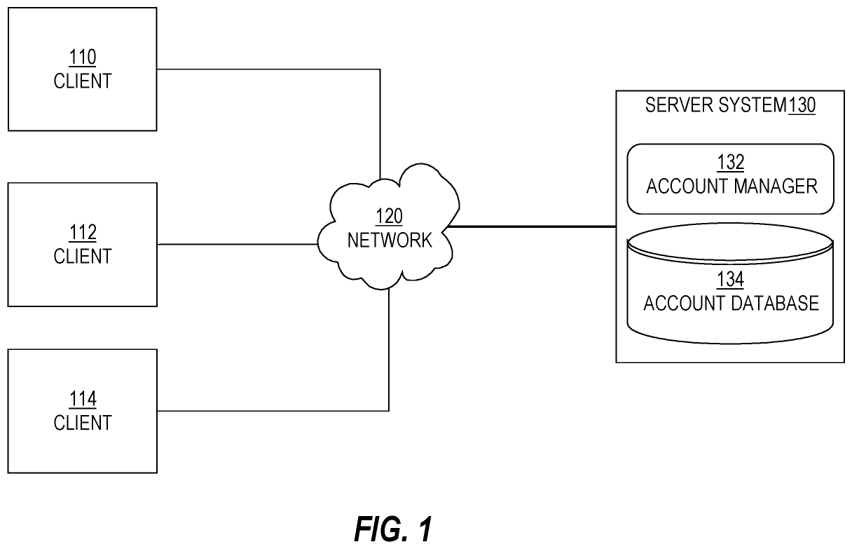

FIG. 1 is a block diagram that depicts an example system 100 for processing scanned business cards, in an embodiment. System 100 includes clients 110-114, network 120, and server system 130. Although only three clients 110-114 are depicted, more clients may be communicatively coupled to server system 130 over network 120.

Each of clients 110-114 is an application or computing device that is configured to communicate with server system 130 over network 120. Examples of computing devices include a laptop computer, a tablet computer, a smartphone, a desktop computer, a personal digital assistant (PDA), and a scanning device that is configured to generate electronic scan data based on information reflected on a physical medium, such as paper, a printed photo, or a business card. Thus, a computing device may include camera components that are capable of taking a picture (i.e., creating a digital image of a camera view). An example of a client application that is used to communicate with server system 130 is a native application that is installed and executed on a local computing device and that is configured to communicate with server system 130 over network 120. Another example of a client application is a web application that is downloaded from server system 130 and that executes within a web browser running on a computing device. Each of clients 110-114 may be implemented in hardware, software, or a combination of hardware and software.

Through client 110, a user is able to upload digital images and/or other digital information to server system 130. Later, the user may employ client 110 to interact with server system 130 to retrieve, supplement, and/or update digital information (or simply “data”).

Network 120 may be implemented on any medium or mechanism that provides for the exchange of data between client 110 and server system 130. Examples of network 120 include, without limitation, a network such as a Local Area Network (LAN), Wide Area Network (WAN), Ethernet or the Internet, or one or more terrestrial, satellite or wireless links.

### Server System

Although depicted as a single element, server system 130 may comprise multiple computing elements and devices, connected in a local network or distributed regionally or globally across many networks, such as the Internet. Thus, server system 130 may comprise multiple computing elements other than account manager 132 and account database 134.

Account manager 132 manages access to, and updates to, accounts stored in account database 134. For example, account manager 132 receives account data from computing devices (e.g., client 110) over network 120, where the account data is input by users (e.g., selecting characters on a physical or graphical keyboard) operating the computing devices. Account manager 132 may create and/or update accounts based on data extracted from a digital image.

Account database 134 comprises information about multiples accounts. Account database 134 may be stored on one or more storage devices (persistent and/or volatile) that may reside within the same local network as server system 130 and/or in a network that is remote relative to server system 130. Thus, although depicted as being included in server system 130, each storage device may be either (a) part of server system 130 or (b) accessed by server system 130 over a local network, a wide area network, or the Internet.

In a social networking context, server system 130 is provided by a social network provider, such as LinkedIn. In this context, each account in account database 134 corresponds to a different entity, examples of which include users, groups of users, and organizations (e.g., companies, associations, government agencies, etc.). Each account includes information about the account and a profile, each provided by a different user or group/organization representative. Examples of account information include when the account was created, a log of changes to the account, identities of one or more owners of the account, and financial transaction information related to the account.

An organization's profile may include an organization name, a website, one or more phone numbers, one or more email addresses, one or more mailing addresses, a company size, a logo, one or more photos or images of the organization, an organization size, and a description of the history and/or mission of the organization.

A user's profile may include a first name, last name, an email address, residence information, a mailing address, a phone number, one or more educational/academic institutions attended, one or more academic degrees earned, one or more current and/or previous employers, one or more current and/or previous job titles, a list of skills, a list of endorsements, and/or names or identities of friends, contacts, or connections of the user in the user's social network, and derived data that is based on actions that the user has taken.

Examples of actions that a user has taken include jobs to which the user has applied, views of job postings, views of company pages, private messages between the user and other users in the user's social network, and public messages that the user posted and that are visible to users outside of the user's social network (but that are registered users/members of the social network provider).

Some data within a user's profile (e.g., work history) may be provided by the user while other data within the user's profile (e.g., skills and endorsement) may be provided by a third party, such as a “friend,” connection, colleague of the user.

Server system 130 may prompt users to provide profile information in one or more ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another automatic process). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

### Process Overview

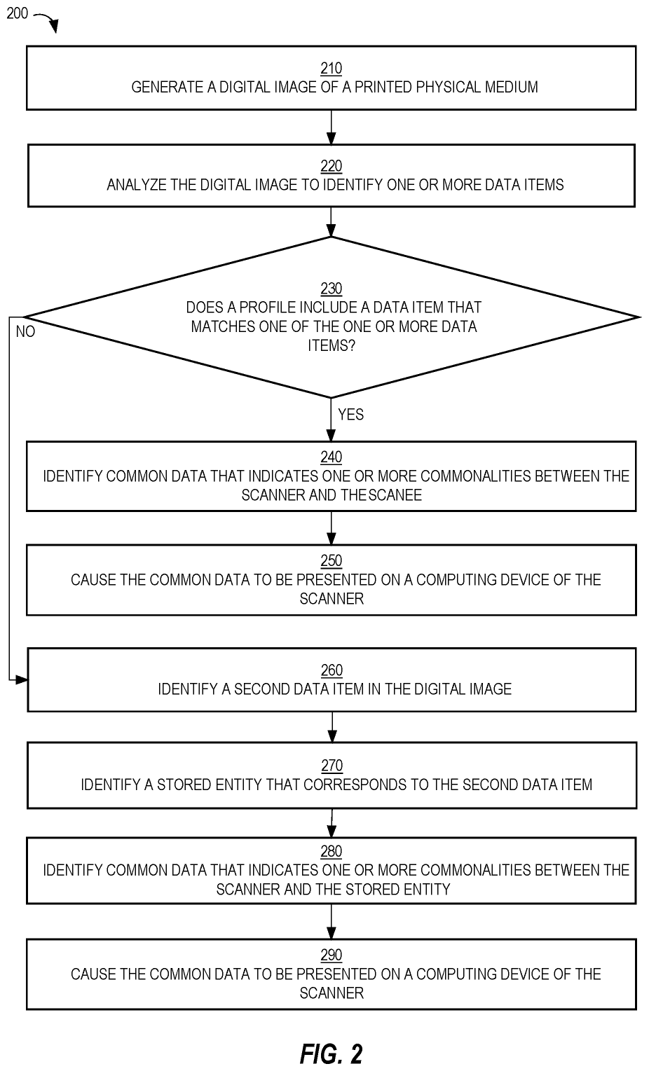

FIG. 2 is a flow diagram that depicts an example process 200 for processing scanned business cards, in an embodiment. Different elements of process 200 may be implemented by client 110 and server system 130.

At block 210, a digital image of a printed physical medium is generated. An example of a printed physical medium is a business card. Another example of a printed physical medium is a projector screen with an image displayed thereon. The printed physical medium includes information about an entity, such as a user or organization, examples of which include a company, a school or academic institution, a charitable organization, a government agency, a business association, and a community organization. The digital image may be generated by client 110 or by a computing device upon which client 110 executes.

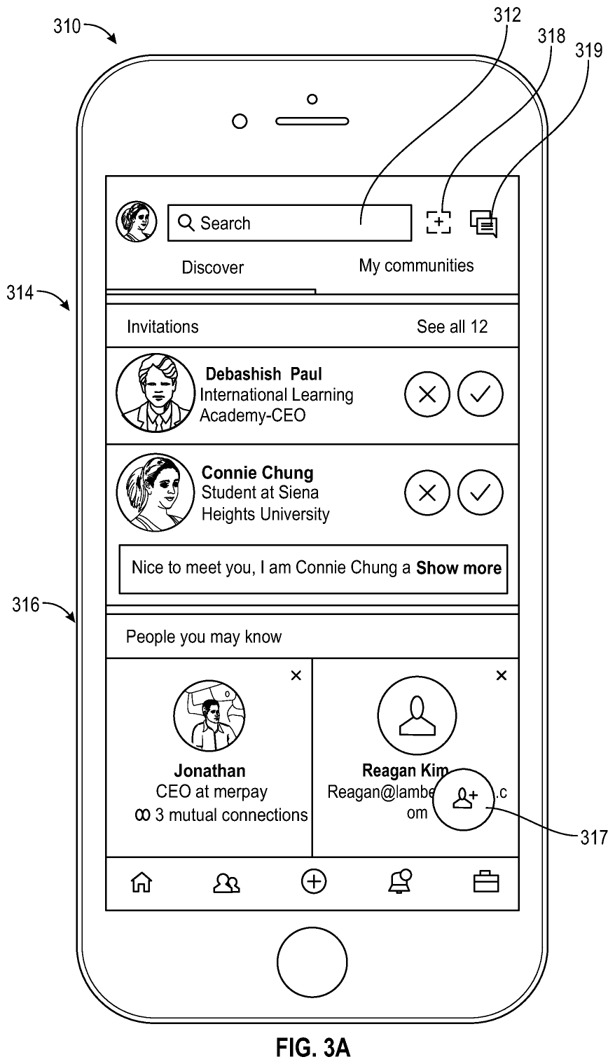

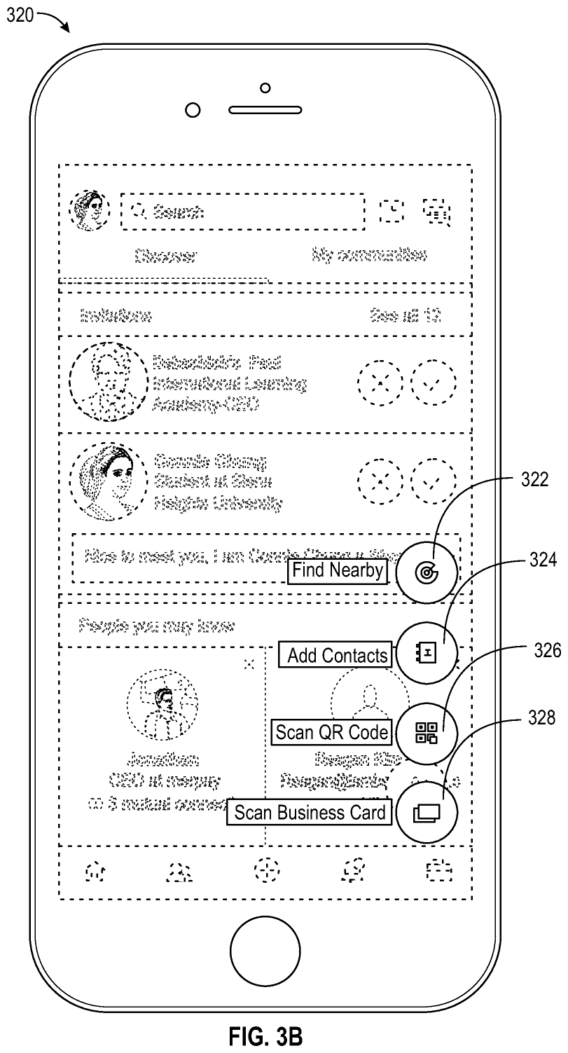

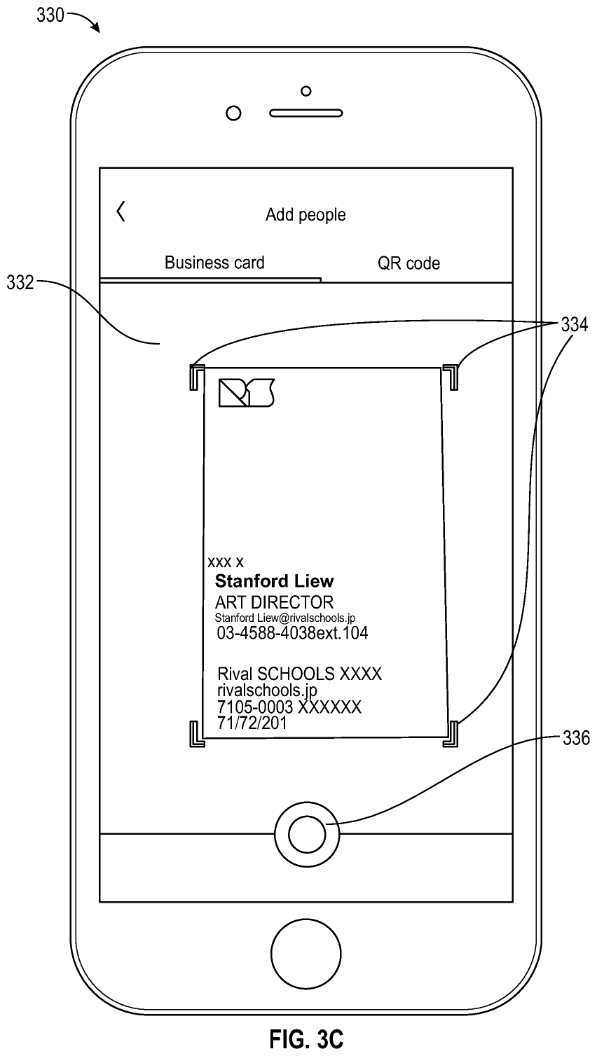

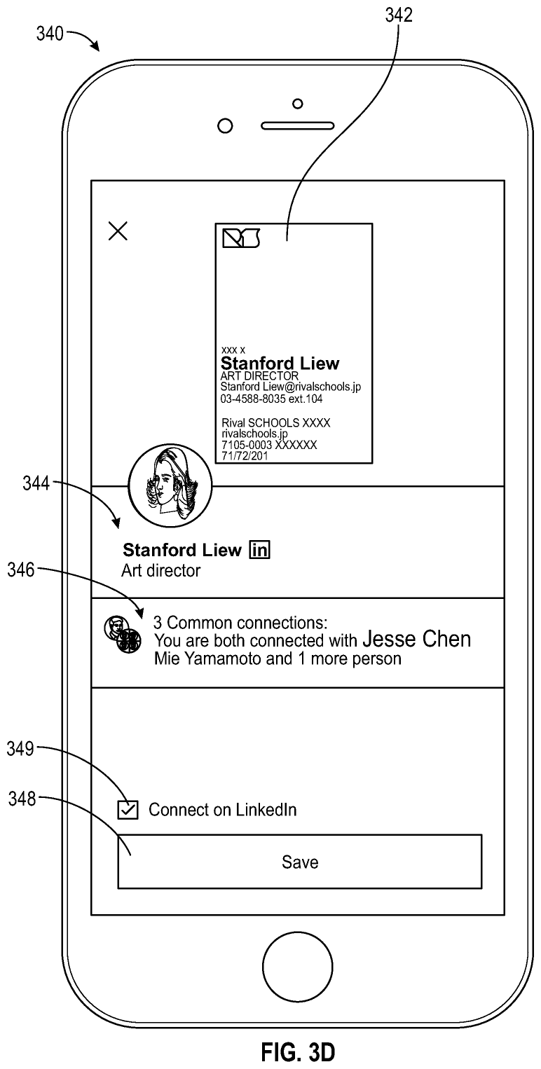

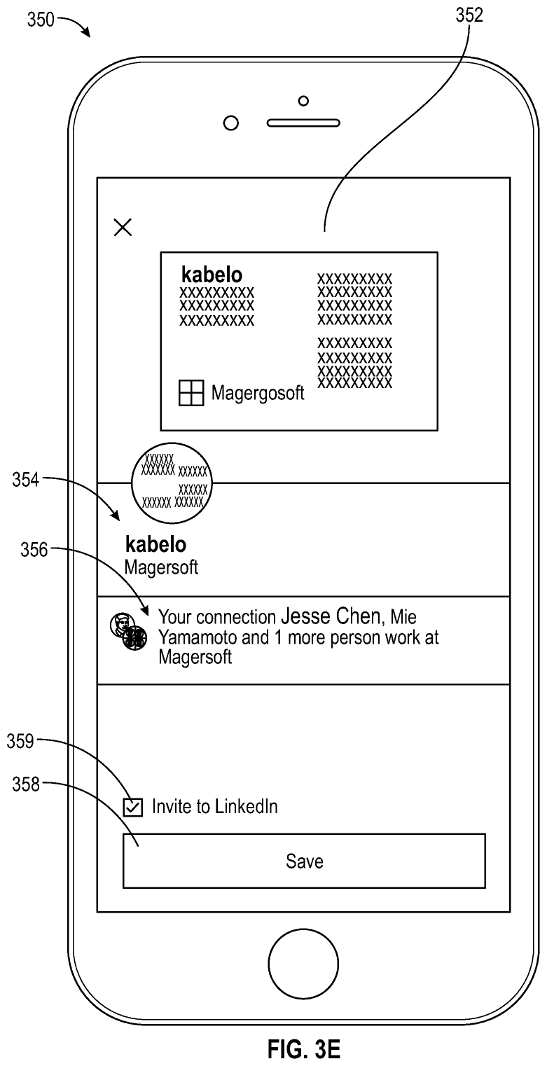

FIGS. 3A-3E are example screenshots of a user interface of a client application that executes on a computing device and that is used to process digital images generated by the computing device, in an embodiment. The client application has access to a camera that is embedded in the computing device. The client application may be a native application or a web application.

FIG. 3A is a screenshot of user interface 310 that includes a search field 312, a list of invitations 314, a list of people the viewer may know (PYMK) 316, a Fab button 317, a scan option 318, and a message option 319. Search field 312 allows a user to enter a search query, either through selecting textual characters on a digital keyboard (not depicted) or through voice. List of invitations 314 allows the user to view, accept, and deny invitations from other users (e.g., to connect in an online social network or “connection network”) who are not yet connected to the user. List of PYMK 316 allows a user to, with one or two user selections, send an invitation to another user to connect with the user in the user's online social network. Scan option 318 allows a user to take a picture of a printed physical medium and process the resulting digital image. Message option 319 allows a user to compose a digital message and send the digital message to another user, such as one that is already in the user's online social network. User selection of scan option 318 causes a user interface 330 (depicted in FIG. 3C) to be presented. User selection of Fab button 317 causes a user interface 320 (depicted in FIG. 3B) to be presented.

User interface 320 includes four user selectable options: find nearby option 322, add contacts option 324, scan QR code option 326, and scan business card option 328. User selection of scan business card option 328 causes a user interface 330 (depicted in FIG. 3C) to be presented.

User interface 330 includes: (1) a camera view 332 that presents the current contents of what a camera is currently pointing at, (2) viewing brackets 334 (which may be either static (i.e., fixed in place) or follow the detected business card in the camera view) that allows the user to see where one or more computer processes that will scan a resulting digital image will focus their analysis; and (3) an image generation button 336 that, when selected, causes a digital image of the current contents of camera view 332 to be generated and stored. Alternatively, image generation button 336 is unnecessary. Instead, a process in the client application detects when a printed physical medium is within viewing brackets 334 and when the camera is stable long enough to generate a clear digital image of the printed physical medium.

At block 220, the digital image is analyzed to identify one or more data items. One or more optical character recognition (OCR) techniques may be used to recognized and extract characters and words from the digital image. A result of the OCR technique(s) on the digital image is analysis data, which contains the one or more data items. One or more pre-processing techniques may be used to convert the digital image into a different format, such as from a .png file to a .jpg file, before an OCR technique is applied.

An OCR technique may be implemented by the same or different (e.g., remote) device as the device that generates the digital image. For example, a user operating client 110 (e.g., a mobile device that includes a camera) takes a picture of a business card of the scanee. The picture (or digital image) is then transmitted over network 120 to server system 130, which implements an OCR technique relative to the digital image. As another example, client 110 implements the OCR technique relative to the digital image.

The one or more data items that are identified in block 220 include information about an entity, such as the entity's first name and last name (if the entity is a user), organization name, organization address, job title, job function, email address, business phone number, personal phone number, personal mailing address, and website address. Some data items are uniquely identifying of an entity, such as an email address and a phone number (if the phone number is a personal phone number, even one issued by an organization), while other data items are not uniquely identifying of an entity, such as first and last names, organization name, mailing address, and website address.

A business card may label at least some of the data items. For example, the business card may have the phrase “First Name:” that precedes a string of consecutive characters. As another example, the business card may have the word “Address:” that precedes a string of characters that is typical of an address. As another example, the business card may have the word “Phone Number:” that precedes a string comprising 10 numeric characters and two or more periods (“.”), dashes (“-”), or spaces (“ ”) among the numeric characters. In this way, an OCR technique may rely on the labels in order to automatically associate the appropriate label with the individual data items (or associate each data item with the appropriate attribute) with a high degree of confidence. A label indicates an information type, such as first name, last name, company name, university name, company address, personal address, work phone number, personal phone number, and email address. Alternatively, a business card may not have any labels. Thus, an OCR technique analyzes patterns in the text that is extracted from a digital image.

In a related embodiment, an OCR technique merely recognizes characters in a digital image and an order among of the characters and it is the responsibility of another software process and/or hardware component to determine how to delineate among the data items and label them appropriately. For example, since many phone numbers, email addresses, web domain names, and addresses follow certain patterns, such data items may be easier to identify. Identifying and labeling the remaining data items (such as person name and company name) may be easier once the other data items are already identified and labeled.

As used herein, “scanning” refers to extracting data items from a digital image of a physical medium and, optionally, labeling each data item with an information type. “Scanning” may also include generating the digital image. If “scanning” includes generating the digital image, then scanning involves both client 110 and server system 130.

At block 230, it is determined whether a profile in a profile database includes a data item that matches one of the one or more identified data items. Block 230 may be performed by account manager 132 (or another process that is not depicted) accessing account database 134. Block 230 may involve comparing one of the identified data items to a corresponding data item in each profile of multiple profiles. For example, if one of the identified data items is an email address, then the email address is compared to an email address associated with each profile in account database 134 until a profile is found or all profiles are considered. To optimize the lookup, an index may be used that is created based on the column or data field that corresponds to, in this example, email address.

Block 230 may involve a fuzzy match where server system 130 is confident that, although there is not an exact match using any of the uniquely identifying data items (e.g., email address), there is a match with one or more non-uniquely identifying data items, such as first and last names, company name, and job title.

If the decision in block 230 is positive, then process 200 proceeds to block 240; otherwise, process 200 proceeds to block 260.

At block 240, common data is identified that indicates one or more commonalities between the viewer/scanner and the scanee (or the user whose information is contained on the printed physical medium, such as a business card). For example, one or more connections of the scanee are determined to be the same connections as one or more connections of the scanner. Thus, the one or more connections are common connections between the scanee and the scanner.

At block 250, the common data is presented on the computing device of the scanner. Block 250 may involve transmitting the common data (and potentially other data) from server system 130 over network 120 to client 110.

FIG. 3D is a screenshot of user interface 340 that is displayed via client 110 and that depicts a copy of the generated digital image 342, profile data 344 of the scanee that is retrieved from account database 134, common data 346 between the scanee and the scanner, a save button 348 to save the information pertaining to the scanee in association with an account of the scanner, and a connection option 349 that, when selected, causes a connection request to be sent to the scanee when the scanner selects save button 348. In this example, profile data 344 includes a profile picture of the scanee, a name of the scanee, and a job title of the scanee. Also, in this example, common data 346 includes (1) an indication of the number of common connections (in an online network) between the scanee and the scanner and (2) names of two of those common connections.

A connection request invites the scanee to accept an invitation from the scanner to become a connection of the scanner. A “connection” between two user entities associates the two user entities in an online connection network or graph. If a connection request is sent, then the connection request may be sent through one or more delivery channels, examples of which include email, text, and in-app messaging. Before a connection request is sent, the user interface may be updated to allow the user to customize a message that will be included with the connection request to the scanner.

In the depicted example, connection option 349 is automatically (or is by default) selected. Thus, connection option 349 is an opt-out feature where the scanner must select connection option 349 in order for a connection request to not be automatically sent to the scanee. In other examples, connection option 349 is an opt-in feature, meaning that the scanner must provide input to affirmatively select connection option 349 in order to have a connection request be sent to the scanee.

In a related embodiment, user interface 340 (or a user interface that may be presented in response to one or more user interactions with user interface 340) identifies any differences between profile data of the scanee and data items that are extracted from the printed medium. For example, if a job title indicated in a retrieved profile (from account database 134) corresponding to the scanee is different than a job title that is extracted from the scanee's business card, then that difference is visually indicated. Such an indication may be highlighting the text of the extracted job title, using different font color for the extracted job title relative to other extracted data items, and/or including both job titles in the same user interface. Such a visual indication assists the scanner in knowing that a discrepancy exists.

At block 260, a second data item in the digital image is identified. The second data item may be a non-uniquely identifying data item while the one or more data items identified in block 220 may be uniquely identifying data items. For example, the second data item identified in block 260 may be a company name (e.g., indicating an employer of the scanee) or a school name (e.g., indicating an alma mater of the scanee).

At block 270, a stored entity is identified that corresponds to the second data item. The stored entity is an entity that is associated with a profile or account in account database 134. The stored entity may correspond to a node in a graph of connected nodes, where each node corresponds to a different entity, such as a person, an organization, a job title, a skill, a school, an industry, etc. In the example where the second data item is a name of a company, that company name is used to identify (a) a profile, in account database 134, for that company or (b) a node, in a node graph, that corresponds to the company name.

At block 280, common data is identified that indicates one or more commonalities between the scanner and the stored entity, which is different than the scanee. For example, in the case where the stored entity is a university, then one or more connections of the scanner who attended the university are identified. Thus, block 280 involves identifying one or more entities that are associated with both the scanner and the stored entity.

At block 290, the common data is presented on the computing device of the scanner. Block 290 may involve transmitting the common data (and potentially other data) from server system 130 over network 120 to client 110.

FIG. 3E is a screenshot of user interface 350 that is displayed via client 110 and that depicts a copy of the generated digital image 352, extracted data 354 of the scanee that is extracted from digital image 352, common data 356 between the stored entity and the scanner, a save button 358 to save the information pertaining to the scanee in association with an account of the scanner, and an invite option 359 that, when selected, causes an invitation message to be sent to the scanee when the scanner selects save button 358.

Extracted data 354 includes, in this example, a profile image of digital image 352 (indicating that the scanee was not identified as a member of a particular online network, such as the LinkedIn social network), a name extracted from digital image 352, and an employer name extracted from digital image 352.

An invitation message (generated in response to user selection of invite option 359) invites or prompts the scanee to register with a social network service. The invitation message may be (a) a text message where the destination is a phone number that was extracted from the digital image or (b) an email message where the destination email address is an email address that was extracted from the digital image. In this example, extracted data 354 includes a profile picture of the digital image, a name of the scanee that was extracted from the digital image, and a name of the scanee'e employer, which name is extracted from the digital image. Also, in this example, the scanned entity is the name of the scanee's employer (“Microsoft”) and, therefore, common data 356 includes (1) an indication of the number of connections (in an online network) that the scanner has who also work as the scanned entity and (2) names of two of those connections.

In the depicted example, invite option 359 is automatically (or is by default) selected. Thus, invite option 359 is an opt-out feature where the scanner must select invite option 359 in order for an invitation message to not be automatically sent to the scanee. In other examples, invite option 359 is an opt-in feature, meaning that the scanner must provide input to affirmatively select invite option 359 in order to have an invitation message be sent to the scanee.

### Examples of Insights if the Scanee is a Member

In the examples above, a commonality between a scanner and a scanee who is a member of same online network service (e.g., the service provided by LinkedIn) as the scanner includes a common connection or friend in an online network/graph and a connection that the scanner has at the scanee's employer. Other examples of commonalities (or “insights”) include connections that the scanee has and that are at the same employer as the scanner, a common school attended, past common employers, common (e.g., community, online, business) groups of which the scanner and scanee are members, an indication of how long the scanner and the scanee have been connected (if they are already connected in an online network), overlapping job interests, common skills, and common interests. An example of an overlapping job interest is the scanner searching for jobs (e.g., as indicated in online job search behavior of the scanner) and the scanee having posted a job that matches or roughly matches job postings that the scanner has viewed. An example message that is presented to the scanner in the overlapping job interests scenario is “[Name of scanee] is hiring for a [job title of scanner].” Common interests may be determined based on overlapping hashtag follows of both the scanner and the scanee. Common interests may also be determined based on online page views of both the scanner and the scanee, which page views indicate that both the scanner and scanee have interest in similar content. The online page views may be of the same online pages or of different pages that are associated with the same topic(s).

Other insights that may be presented to a scanner are not based on commonalities between the scanner and the scanee, but are rather based on interesting and potentially relevant information about the scanee. Examples of such insights include an online post that the scanee has posted in the last period of time (e.g., last week), the top three highly-rated skills of the scanee, and a person that the scanee can introduce to the scanner.

### Examples of Insights if the Scanee is not a Member

In the examples above, a commonality between a scanner and a scanee who is not a member of the same online network service as the scanner includes one or more connections of the scanner who attended a university that is identified on a business card of the scanee. Other examples of commonalities (or “insights”) include connections of the scanner who are at the same employer/company as the scanee, people who are at scanee's company who used to work at scanner's company, a common school attended (if the school is indicated on the scanee's business card, for example), and employees who work at the scanee's employer and who went to the scanner's school.

### Personal Database of Scanned Printed Media

In an embodiment, a user is associated with a list of printed physical media (e.g., business cards) of which the user has previously taken a picture using client 110 or another client application. The list of printed media is stored in association with the user's account that is stored in account database 134. The list of printed media and the corresponding information extracted from the printed media and/or from account database 134 acts as a “personal database” of the user/scanner. Thus, when the user accesses his/her profile information through account manager 132, the user is able to view the list of printed media.

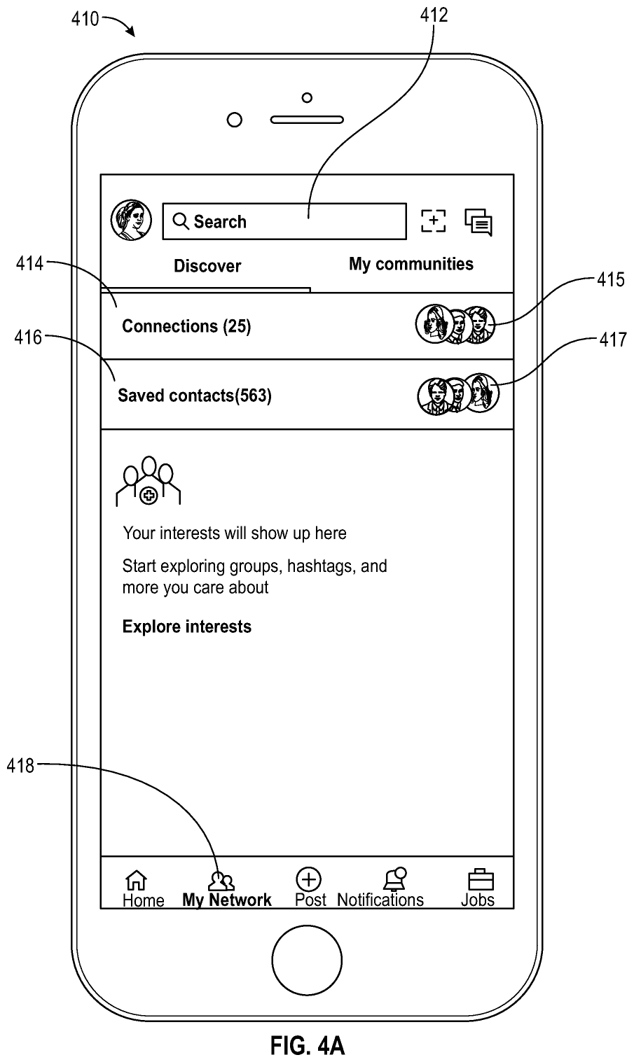

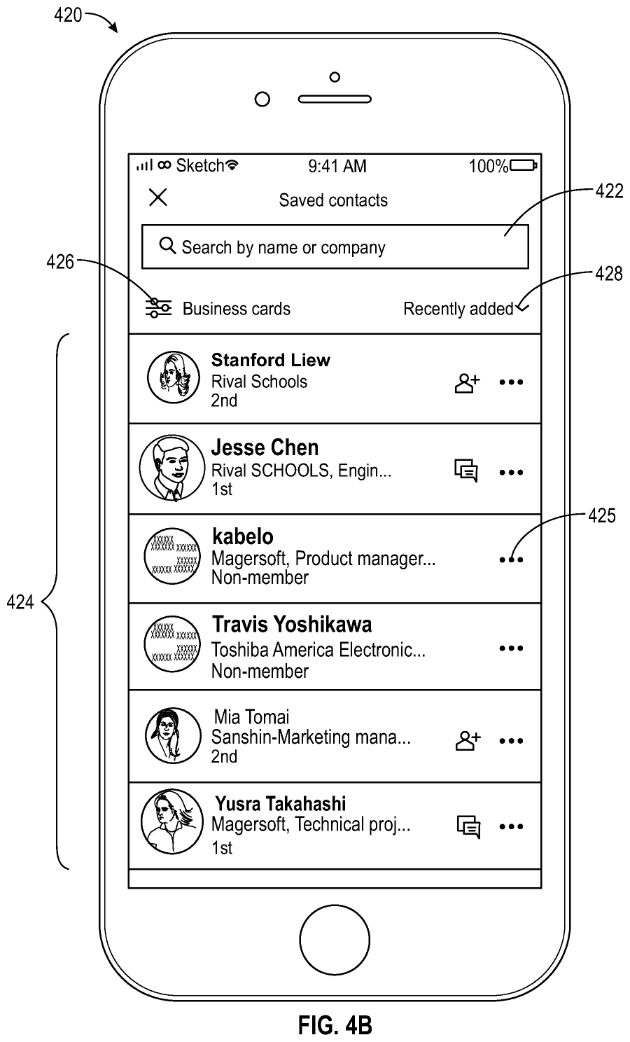

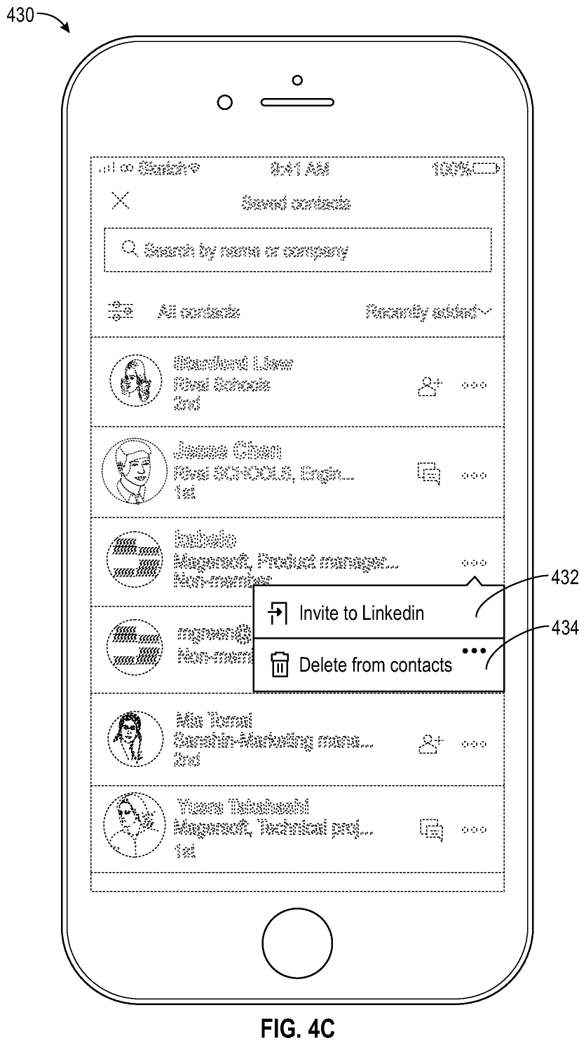

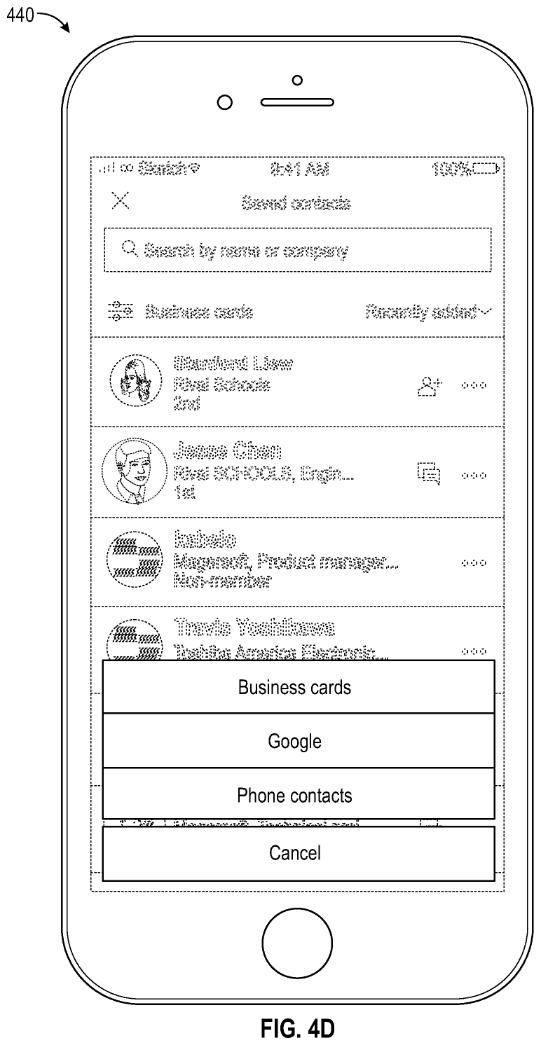

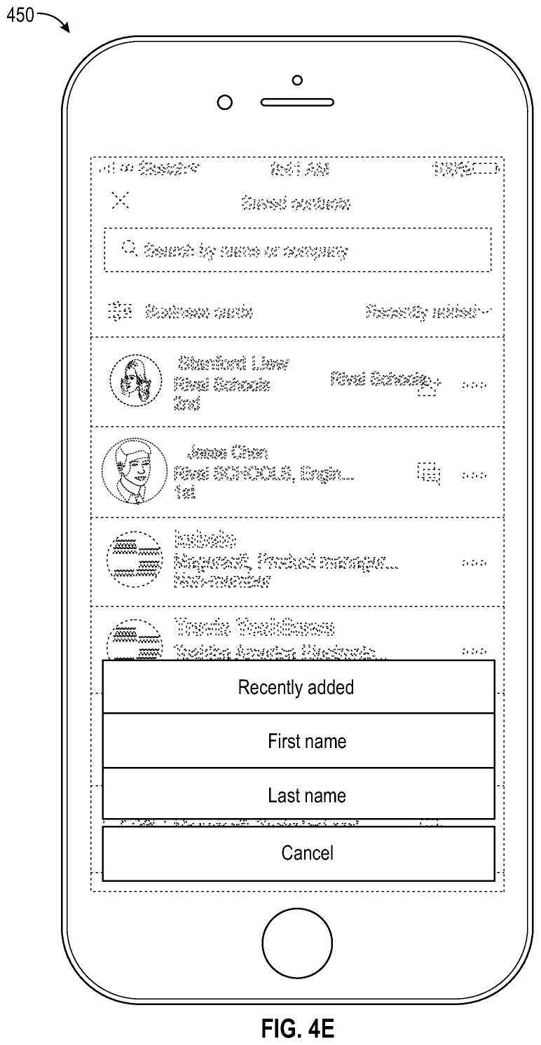

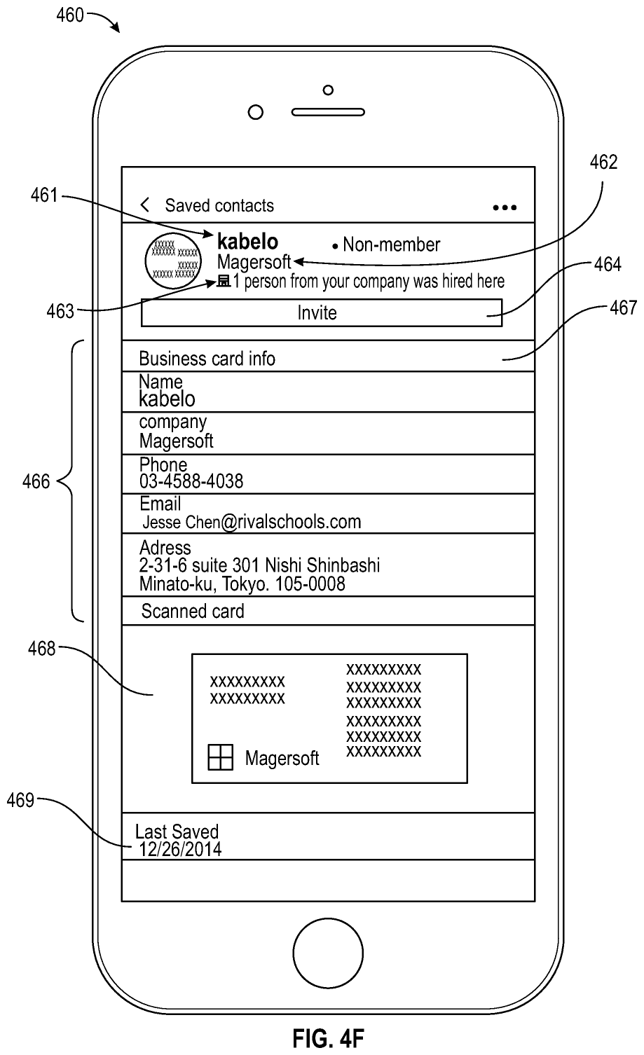

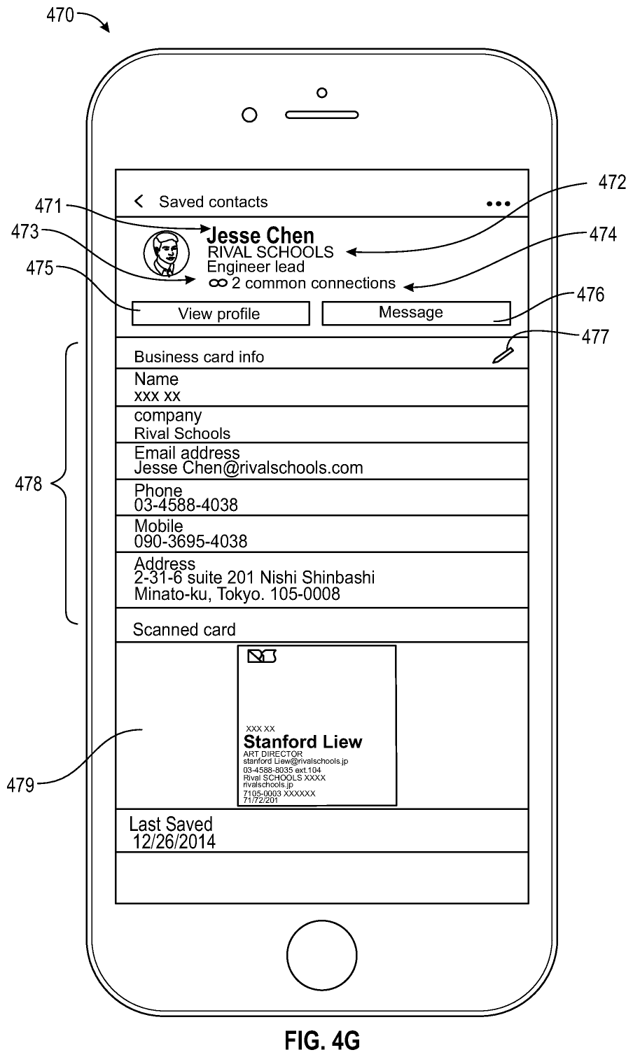

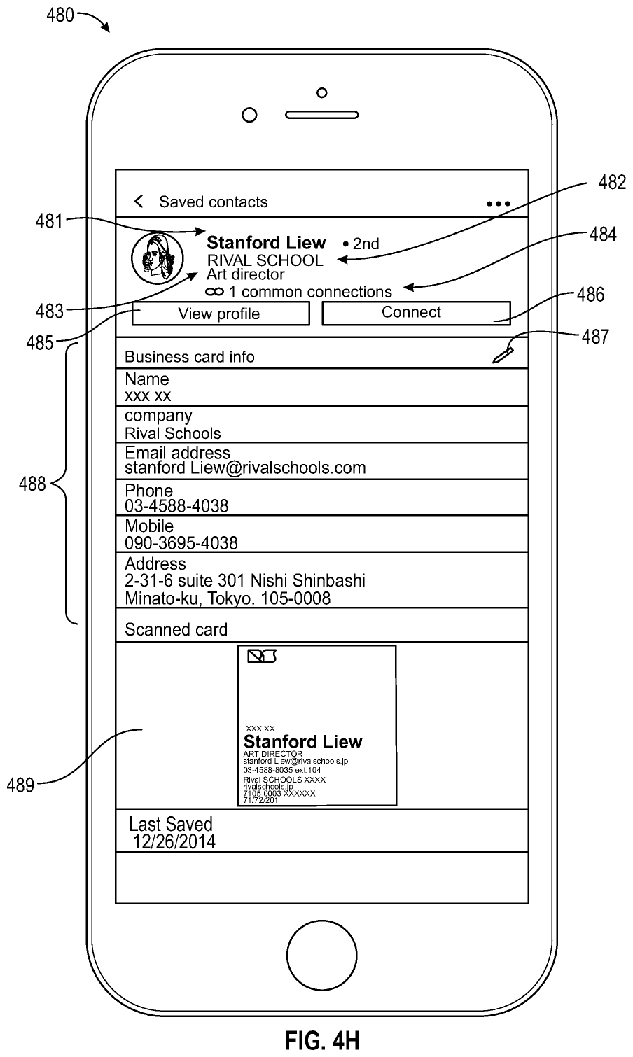

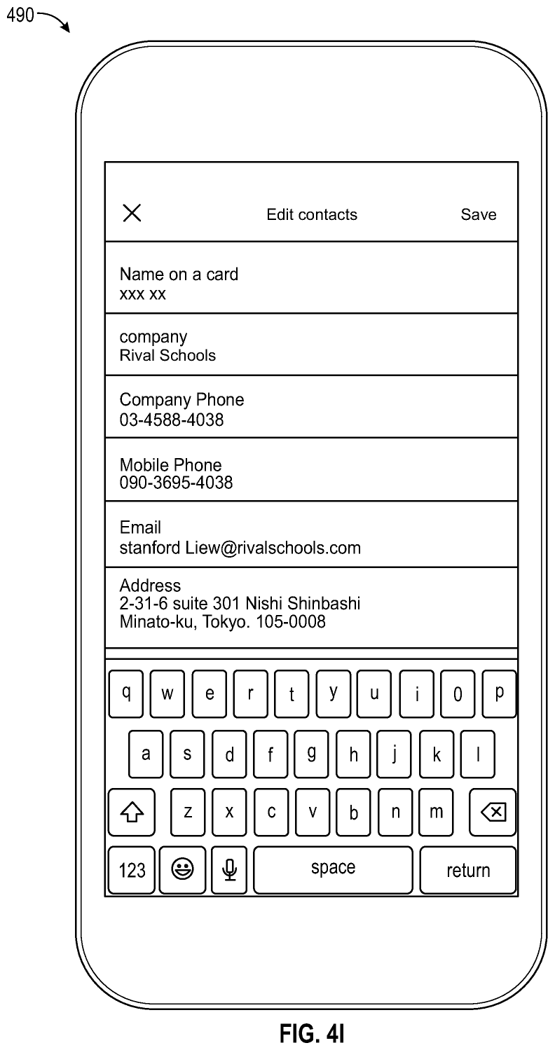

FIGS. 4A-4I are example screenshots of a user interface of a client application that executes on a computing device and that is used to present information about scanees to a scanner, in an embodiment.

FIG. 4A is a screenshot of a user interface 410 that includes a search field 412, a connections button 414, and a saved contacts button 416. The elements of user interface 410 may be displayed in response to selection of the “My Network” button 418. Search field 412 allows a user to enter one or more search criteria (e.g., a person name, a company name, a school name, a degree, a skill) that, when entered, causes the client application executing on the computing device (or server system 130) to perform a search of the connections and saved contacts associated with the user. Data (or a portion thereof) about the connections and/or the saved contacts may be stored locally to allow for a faster search. Alternatively, all or a portion of the data that is searched is stored remotely at server system 130.

Connections button 414 includes multiple profile images 415 of connections of the user along with a number indicating a number of current connections that the user has, which is 25 in this example.

Saved contacts button 416 also includes multiple profile images 417 of contacts of the user, along with a number indicating a number of contacts that the user has saved, which is 563 in this example. The contacts associated with the user may include contacts whose printed media (e.g., business cards) the user has scanned. Additionally or alternatively, the contacts associated with the user may include contacts whose contact information is stored locally on the user's computing device. Thus, the number of contacts may be at least partially based on a number of business cards that the user has scanned. User selection of saved contacts button 416 causes a user interface 420 (depicted in FIG. 4B) to be presented in place of user interface 410.

FIG. 4B is a screenshot of user interface 420 that includes a search field 422, a list of contacts 424, a type filter 426, and a sort feature 428. Search field 422 allows a user to enter one or more search criteria that, when entered, causes the client application to perform a search of the saved contacts only. List of contacts 424 includes multiple entries (six in the depicted example), each corresponding to a different contact. Entries may include a profile image that comes from account database 134 (if the contact has an account with account database 134) or a profile image of the digital image of a business card of the corresponding contact.

Each entry includes a name of the contact, an employer of the contact (which may come from account database 134 or from a printed medium), a job title (if known), and a connection degree that indicates how close the contact is to the user in an online network (if the contact is a member of the online network) or member status that indicates whether the contact is a member of the online network. In the depicted example, two contacts are not members and four contacts are members, two of which are first-degree connections and two of which are second-degree connections. If a contact is a first-degree connection, then the corresponding entry includes a message icon that, if selected, allows the user to compose and send a message to the contact. If a contact is a second-degree connection, then the corresponding entry includes an invite icon that, if selected, cause an invitation message to be sent to the contact, which message allows the contact to register with the online network.

If a contact is not a member, then user selection of option 425 causes a user interface 430 (depicted in FIG. 4C) to be displayed. User interface 430 allows a user to invite 432 the corresponding contact to register with an online network service (such as LinkedIn) and to delete 434 the contact from list of contacts 424.

User selection of type filter 426 allows the user to change the default type filter, which default may be to show contacts whose business cards were scanned by the user. Another possible filter may be to show contacts whose information is found on the user's computing device through a different means, such as a contacts list that is managed by another application executing on the user's computing device. Another possible filter may be to show contacts from a different source, such as a third-party contacts management service that executes remotely (“in the cloud”) and is accessible through the Internet. Examples of types of filters are depicted in a user interface 440 (depicted in FIG. 4D), which is presented in response to user selection of type filter 426.

Sort feature 428 allows list of contacts 424 to be sorted in one of multiple ways. In the depicted example, list of contacts 424 is stored based on when the contact was added to the client application or to the computing device. Each contact may be associated with a timestamp that indicates a date and/or time when information about the corresponding contact was received. Other sorting criteria may include an alphabetical sort on different types of data items, such as contact first name, contact last name, name of contact's employer, and name of school/university that the contact attended. Examples of types of sort criteria are depicted in a user interface 450 (depicted in FIG. 4E), which is presented in response to user selection of sort feature 428.

User selection of a contact in list of contacts 424 causes information about the contact to be presented, examples of such information are depicted in FIGS. 4F-4H.

### Non-Member Contact

FIG. 4F is a screenshot of a user interface 460 that is presented in response to user selection of a contact who is not a registered member of a particular online network. User interface 460 includes information that has been extracted from a digital image of the contact's business card, such as first and last names 461, a name 462 of an employer, an indication 463 of a number of people from the user/scanner's company that was hired at the contact's/scanee's employer, an invite button 464, editable extracted information 466, an edit option 467, an image 468 of the contact's business card, and a date 469 in which the digital image (or the most recent data about the contact) was last saved. Editable extracted information 466 (comprising data items from “Name” through “Address”) comes from the digital image of the business card and was used to automatically populate five data fields of the corresponding contact record: name, company, phone number, email address, and mailing address.

### Connected Member Contact

FIG. 4G is a screenshot of a user interface 470 that is presented in response to user selection of a contact who is a registered member of a particular online network, has a business card that the user scanned, and is connected to the user in the user's social network. User interface 470 includes information that has been extracted from a profile of the contact (which profile may be stored in account database 134), such as first and last names 471, a name 472 of an employer, a job title 473, an indication 474 of a number of common connections between the contact/scanee and the user/scanner, a view profile button 475, a message button 476, an edit option 477, editable extracted information 478, and an image 479 of the contact's business card. Editable extracted information 478 (comprising data items from “Name” through “Address”) comes from the digital image of the business card and was used to automatically populate the six data fields of the corresponding contact record: name, company, email address, work phone number, mobile phone number, and mailing address.

User selection of view profile button 475 causes additional profile data to be retrieved from the corresponding profile in account database 134 and presented in the user' computer display. User interface 470 is updated to include such additional profile data.

User selection of message button 476 allows the user to compose and send a message to the contact.

User selection of edit option 477 allows the user to change the contents of editable extracted information 478. For example, the user may notice that the OCR process that extracted data items from the business card did not properly recognize some of the data items. As another example, the user may have personal knowledge that some data items extracted from the business card are out of date and do not reflect an accurate understanding of the contact, such as the extracted email address of the contact being out of date.

### Non-Connected Member Contact

FIG. 4H is a screenshot of a user interface 480 that is presented in response to user selection of a contact who is a registered member of a particular online network, has a business card that the user scanned, and is not connected to the user in the user's social network. User interface 480 includes information that has been extracted from a profile of the contact (which profile may be stored in account database 134), such as first and last names 481, a name 482 of an employer, a job title 483, an indication 484 of a number of common connections between the contact/scanee and the user/scanner, a view profile button 485, a connect button 486, an edit option 487, editable extracted information 488, and an image 489 of the contact's business card. Editable extracted information 488 (comprising data items from “Name” through “Address”) comes from the digital image of the business card and was used to automatically populate the six data fields of the corresponding contact record: name, company, email address, work phone number, mobile phone number, and mailing address.

User selection of view profile button 485 causes additional profile data to be retrieved from the corresponding profile in account database 134 and presented in the user' computer display. User interface 480 is updated to include such additional profile data.

User selection of connect button 486 causes a connection request message to be sent to the contact, inviting the contact to connect to the user in the user's social network.

User selection of edit option 487 allows the user to change the contents of editable extracted information 488. User selection of edit option 487 causes a user interface 490 (depicted in FIG. 4I) to be presented in place of user interface 480.

### People You May Know

In an embodiment, a user's personal database is used to identify people that the user may know and to whom the user may be interested in connecting in an online network, such as an online social network. For example, a user, operating a computing device, may visit a web site hosted by server system 130, which generates web page data in response to each request that the computing device transmits to server system 130. Some of the web page data may include a list of people that the user may know (PYMK) based on one or more criteria, such as other users who work at the same company as the user, who attended the same university as the user, who share some of the same connections with the user, who have the same job title and work in the same industry and geographic location as the user, etc.

Thus, one of the people indicated in the PYMK list for a particular user may include a user indicated on a printed medium of which the particular user scanned or took a picture. In this way, even though a scanner might not have caused a message to be transmitted to a scanee at the time the scanner took a picture of the scanee's business card, the scanner may be reminded of the scanee at a later time, which may be a more appropriate time to reach out to the scanee.

In a related embodiment, a person indicated in a PYMK list is one who is a registered member of an online network with which the scanner is also a registered member. A “guest you may know” (GYMK) is a person who is not a registered member of the online network with which the scanner is also a registered member. Thus, when visiting web pages generated by server system 130 for a particular scanner, some of the web pages may include a GYMK, at least one of which includes a person whose printed medium was “scanned” by the scanner and who is not (or is not believed to be) a registered member of the online network.

### Profile Edit Notification

In some situations, user information that is contained on a printed medium, such as a business card, may be out of date. For example, after a user creates his/her online profile (stored in account database 134), the user changes employers and obtains a new job title. The user then obtains a new business card that contains the new information and passes copies of the new business card to one or more other users, at least one of which scans the new business card. If the user is a registered member of an online network that is hosted or maintained by server system 130, then information about that user in his/her online profile may be used to determine any inconsistencies with the information contained on the business card, presuming that the business card contains more up-to-date information than the online network.

In an embodiment, server system 130 detects that one or more data items extracted from a scanee's printed medium is different than the corresponding one or more data items identified in a profile or account of the scanee in account database 134. In response to detecting the inconsistency, server system 130 causes an edit notification to be generated and sent to the scanee, such as to an online message account of the scanee. The edit notification may be in the form of an email message, a text message, or an in-app message. The edit notification may invite the scanee to update his/her online profile or business card without indicating which data fields might be out of date. Alternatively, the edit notification may indicate which data fields have inconsistent information and, optionally, what the corresponding data items are. For example, the edit notification indicates, for each data field in which there is an inconsistency, a data item extracted from the printed medium and a data item from the online profile. For example, if there is an inconsistent in employer name, then the edit notification includes “Employer Name” and includes the employer name extracted from a business card and the employer name retrieved from the online profile.

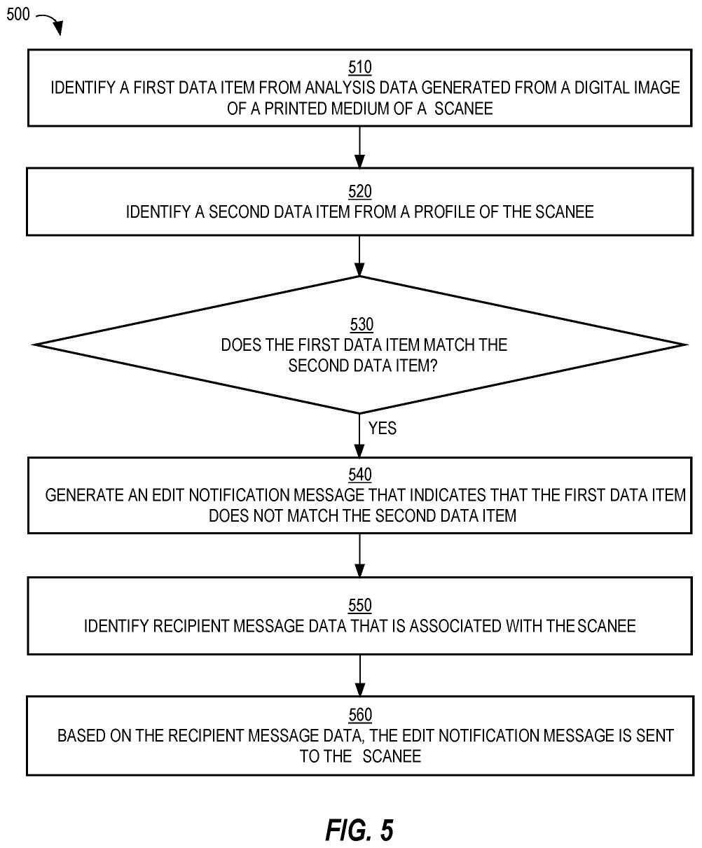

FIG. 5 is a flow diagram that depicts an example process 500 for generating edit notification messages, in an embodiment. Process 500 may be implemented by server system 130.

At block 510, a first data item from analysis data generated from a digital image of a printed medium (e.g., a business card) of a scanee is identified.

At block 520, a second data item from a profile of the scanee is identified. For example, if the first data item is determined to be a company name, then a value from a company name field from the profile is retrieved. The profile may be retrieved from account database 134 using a uniquely identifying data item from the analysis data.

At block 530, it is determined whether the first data item matches the second data item. Block 530 may be an exact match or a near/fuzzy match. One or more preprocessing techniques may be performed on the first data item and/or second data item prior to performing the match/comparison. Examples of preprocessing include correcting misspellings, converting all text to lowercase (in the case of phonetic languages, such as English), and translating one or both of the data items from one written language to another (e.g., Spanish to English).

At block 540, in response to determining that the first data item does not match the second data item, an edit notification message that indicates that the first data item does not match the second data item is generated.

At block 550, recipient message data that is associated with the scanee is identified. Examples of recipient message data include an email address, a phone number (to send a text message), and an account identifier (to send an in-app message). The recipient message data may be stored in the online digital profile of the scanee or in the account of the scanee in account database 134.

At block 560, based on the recipient message data, the edit notification message is caused to be sent to the scanee. For example, server system 130 sends the edit notification message over network 120 to client 110.

Process 500 may be repeated for each data item reflected in the analysis data (or extracted from the digital image). Thus, multiple extracted data items may be identified as being different than their corresponding data items in the retrieved profile. In such a scenario, a single edit notification message may identify multiple discrepancies.

In a related embodiment, an extracted data item from a digital image is compared to multiple data items (1) pertaining to the same information type, (2) stored in association with the same profile, and (3) associated with different timestamps or temporal order. For example, an extracted data item may be job title B and the corresponding profile includes multiple instances of the scanee's job title, including job title A, job title B, and job title C. Job title C may be associated with the oldest timestamp and job title A may be associated with the newest timestamp. Based on determining that job title B is not associated with the newest or most recent timestamp, it is automatically determined (e.g., by server system 130 or by client 110) that the scanee's business card is out of date. Such information may be used in composing an edit notification message. Thus, instead of merely identifying that a discrepancy exists between the scanee's business card and the scanee's profile, the edit notification message may indicate that the business card appears to contain the out-of-date version of the data item, not the scanee's digital profile.

### Enterprise Use Case

Many enterprises have sales teams that work together to sell products or services provided by the enterprise. Each member of a sales team is in charge of identifying potential leads and nurturing those leads (e.g., through online and offline messages and meetings) until a lead makes a purchase of a product or service in question. However, each member typically relies on his/her own personal contacts when reaching out to and nurturing potential leads.

In an embodiment, the personal database of scanned printed media (e.g., business cards) of a team member is leveraged by other members of the enterprise team. Essentially, the scanned business cards of a team member are shared/made accessible to other team members of the same enterprise/company as the team member. For example, user A and user B are on the same enterprise team. User A scanned user C's business card. User C works for company D. Because user A scanned user C's business card, user B can view information about user C. For example, user C's information may be analyzed in response to a search initiated by user B. User B can then ask user A to introduce user C to user B.

In this way, a user's set of scanned business cards allows the user's team to bootstrap on a “people graph” that can be immediately leveraged, even though some of those people are not members of an online network with which users A and B are members.

In an embodiment, each team members scanned business cards are made searchable in a web application that allows the team members to individually search for potential leads who are members of an online network and/or potential leads who are not members of the online network. When performing a search, if a scanee's information satisfies search criteria (e.g., job title and employer name match), then information about the scanee is presented to the user that initiated the search (i.e., the searcher) in the form of a search result, even those the searcher is different than the scanner. The search result may indicate one or more pieces of information pertaining to the scanee, such as a name of the scanee, an employer of the scanee, whether the scanee is a member of the online network, whether the scanee is someone whose business card was scanned, an identification of the scanner, and the digital image of the business card. With the identification of the scanner, the searcher is able to reach out to the scanner in order to obtain a warm introduction to the scanee.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

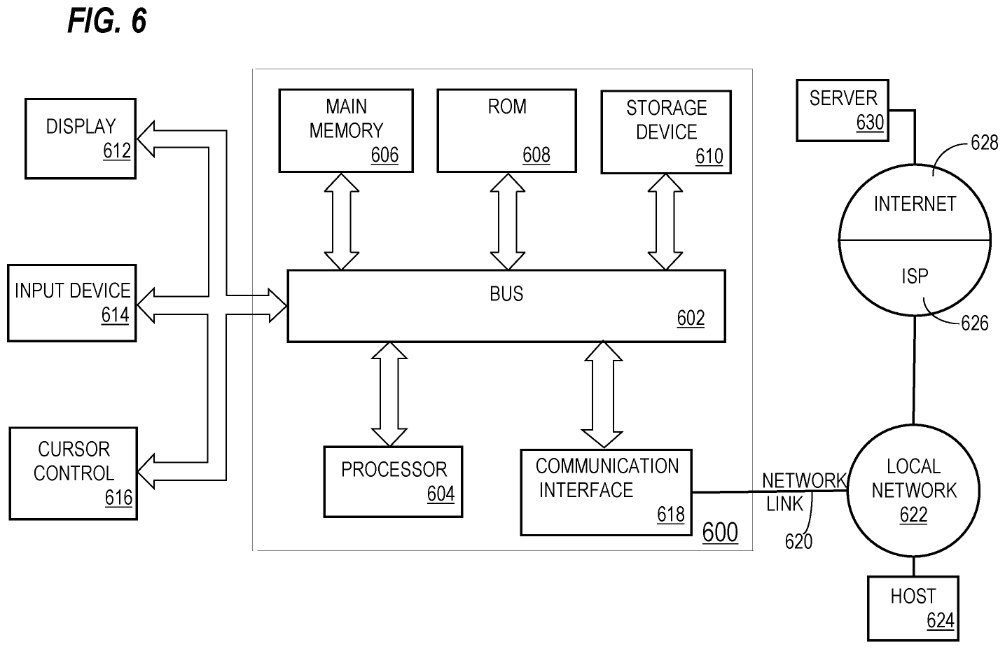

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving analysis data that is generated based on analyzing a digital image of a physical medium, wherein the digital image is generated by a computing device of a scanning entity;
identifying, within the analysis data, one or more data items;
based on the one or more data items, determining whether a profile database includes a profile that includes a data item that matches one of the one or more data items;
in response to determining that the profile database includes the profile that includes the data item that matches the one of the one or more data items, retrieving, from the profile, profile data about a scanned entity that is the subject of content on the physical medium and that is different than the scanning entity;
in response to retrieving the profile data, causing a portion of the profile data to be transmitted over a computer network to be displayed on the computing device of the scanning entity;
wherein the method is performed by one or more computing devices.

2. The method of claim 1, wherein the one or more data items include an email address or a phone number.

3. The method of claim 1, further comprising:
retrieving first entity data associated with a first user of the computing device;
retrieving second entity data associated with a second user of the profile;
determining that the first entity data identifies one or more entities that the second entity data also identifies;
wherein causing the profile data to be transmitted comprises causing common entity data that identifies the one or more entities.

4. The method of claim 3, wherein:
the first entity data is first connection data that identifies connections of the first user in an online network;
the second entity data is second connection data that identifies connections of the second user in the online network;
the one or more entities represent one or more users that are connected to both the first user and the second user.

5. The method of claim 3, wherein:
the first entity data is first organization data that identifies one or more first organizations with which the first user is associated;
the second entity data is second organization data that identifies one or more second organizations with which the second user is associated;
the one or more entities represent one or more organizations with which both the first user and the second user are associated.

6. The method of claim 5, wherein the one or more organizations are one or more academic institutions that both the first user and the second user attended or are one or more companies with which the first user and the second user have been employed.

7. The method of claim 1, further comprising:
identifying one or more first connections of the scanning entity and determining that each of the one or more first connections is employed at a first organization that is listed as an employer of scanned entity of the profile, wherein causing the profile data to be transmitted comprises causing connection data that identifies the one or more first connections to be transmitted over the computer network; or
identifying one or more second connections of the scanned entity of the profile and determining that each of the one or more second connections is employed at a second organization that is listed as an employer of the scanning entity, wherein causing the profile data to be transmitted comprises causing connection data that identifies the one or more second connections to be transmitted over the computer network.

8. The method of claim 1, further comprising:
identifying a first data item from the analysis data;
identifying a second data item from the profile;
determining whether the first data item matches the second data item;
in response to determining that the first data item does not match the second data item:
generating a notification message that indicates that the first data item does not match the second data item;
identifying recipient message data that is associated with the scanned entity;
based on the recipient message data, sending the notification message to an account of the scanned entity.

9. The method of claim 1, wherein the profile data includes a recent post that a second user of the profile posted in an online network, a set of skills of the second user, or an indication of how long the second user and a first user of the computing device have been connected in the online network.

10. The method of claim 1, further comprising:
receiving second analysis data that is generated based on analyzing a second digital image of a second physical medium, wherein the second digital image is generated by a second computing device of a second scanning entity;
storing group data that associates a plurality of entities that includes the second scanning entity and a particular entity that is different than the second scanning entity;
storing association data that associates the second analysis data with the group data;
receiving a search that the particular entity initiates;
in response to receiving the search and based on the association data, causing a portion of the second analysis data to be presented to the particular entity.

11. The method of claim 1, wherein the scanned entity is a first scanned entity, further comprising:
receiving second analysis data that is based on analyzing a second digital image of a second physical medium that contains information about a second scanned entity that is different than the second scanned entity;
identifying a second scanning entity that initiated creation of the second analysis data;
identifying, within the second analysis data, one or more second data items;
based on the one or more second data items, determining whether the profile database includes a profile that includes a data item that matches one of the one or more second data items;
in response to determining that no profile includes a data item that matches any of the one or more second data items, identifying an organization that is indicated in the second analysis data and that is different than the second scanned entity;
determining whether the profile database includes an entry for the organization;
in response to determining that the profile database includes an entry for the organization, identifying one or more entities that are associated with both the second scanning entity and the organization;
causing data about the one or more entities to be presented on a second computing device of the second scanning entity.

12. A method comprising:
receiving analysis data that is based on analyzing a digital image of a physical medium that contains information about a scanned entity;
identifying a scanning entity that initiated creation of the analysis data and that is different than the scanned entity;
identifying, within the analysis data, one or more data items;
determining whether a profile, in a profile database, includes a data item that matches one of the one or more data items;
in response to determining that no profile in the profile database includes a data item that matches any of the one or more data items, identifying an organization that is indicated in the analysis data and that is different than the scanned entity;
identifying the organization in the profile database;
identifying one or more entities that are associated with both the scanning entity and the organization;
causing data about the one or more entities to be presented on a computing device of the scanning entity;
wherein the method is performed by one or more computing devices.

13. The method of claim 12, wherein identifying the one or more entities comprises identifying the one or more entities in the profile database.

14. The method of claim 12, wherein the one or more entities are connections of the scanning entity who are associated with the organization that is an employer of the scanned entity or an academic institution that the scanned entity attended.

15. The method of claim 12, wherein the one or more entities are employees of the organization and attended the same academic institution as the scanning entity.

16. One or more storage media storing instructions which, when executed by the one or more processors, cause:
receiving analysis data that is generated based on analyzing a digital image of a physical medium, wherein the digital image is generated by a computing device of a scanning entity;
identifying, within the analysis data, one or more data items;
based on the one or more data items, determining whether a profile database includes a profile that includes a data item that matches one of the one or more data items;
in response to determining that the profile database includes the profile that includes the data item that matches the one of the one or more data items, retrieving, from the profile, profile data about a scanned entity that is the subject of content on the physical medium and that is different than the scanning entity;
in response to retrieving the profile data, causing a portion of the profile data to be transmitted over a computer network to be displayed on the computing device of the scanning entity.

17. The one or more storage media of claim 16, wherein the instructions, when executed by the one or more processors, further cause:
retrieving first entity data associated with a first user of the computing device;
retrieving second entity data associated with a second user of the profile;
determining that the first entity data identifies one or more entities that the second entity data also identifies;
wherein causing the profile data to be transmitted comprises causing common entity data that identifies the one or more entities.

18. The one or more storage media of claim 16, wherein the instructions, when executed by the one or more processors, further cause:
identifying one or more first connections of the scanning entity and determining that each of the one or more first connections is employed at a first organization that is listed as an employer of scanned entity of the profile, wherein causing the profile data to be transmitted comprises causing connection data that identifies the one or more first connections to be transmitted over the computer network; or
identifying one or more second connections of the scanned entity of the profile and determining that each of the one or more second connections is employed at a second organization that is listed as an employer of the scanning entity, wherein causing the profile data to be transmitted comprises causing connection data that identifies the one or more second connections to be transmitted over the computer network.

19. The one or more storage media of claim 16, wherein the instructions, when executed by the one or more processors, further cause:
identifying a first data item from the analysis data;
identifying a second data item from the profile;
determining whether the first data item matches the second data item;
in response to determining that the first data item does not match the second data item:
generating a notification message that indicates that the first data item does not match the second data item;
identifying recipient message data that is associated with the scanned entity;
based on the recipient message data, sending the notification message to an account of the scanned entity.

20. The one or more storage media of claim 16, wherein the profile data includes a recent post that a second user of the profile posted in an online network, a set of skills of the second user, or an indication of how long the second user and a first user of the computing device have been connected in the online network.
